(19) United States
(12) Patent Application Publication
(10) Pub. No.: US 2017/0127433 A1
(43) Pub. Date: May 4, 2017

(54) METHOD AND APPARATUS FOR SCHEDULING A WIRELESS COMMUNICATION RESOURCE

(71) Applicant: Institute For Information Industry, Taipei (TW)

(72) Inventor: Yi-Ting LIN, New Taipei City (TW)

(21) Appl. No.: 15/343,126

(22) Filed: Nov. 3, 2016

Related U.S. Application Data
(60) Provisional application No. 62/251,038, filed on Nov. 4, 2015.

(51) Int. Cl. H04W 72/12; H04W 74/08

(52) U.S. Cl. CPC H04W 72/12; H04W 74/0816

(57) ABSTRACT

A wireless communication resource scheduling method is provided. The wireless communication resource scheduling method includes: (a) triggering, by an user equipment (UE), a buffer status report (BSR) for an uplink (UL) data transmission; (b) when there is no UL resource for transmitting the BSR at a current transmission time interval (TTI), determining, by the UE, whether to transmit a scheduling request (SR) to an base station at the current TTI by considering a plurality of requirements; and (c) transmitting, by the UE, the BSR using the dedicated UL resource or the next available pre-scheduling UL resource based on a determination of the step (b).

### PRIORITY

This application claims priority under 35 U.S.C. §119(e) to U.S. Provisional Patent Application No. 62/251,038, filed on Nov. 4, 2015, the entirety of which is hereby incorporated by reference herein.

### FIELD

The present invention generally relates to a method and apparatus for scheduling a wireless communication resource, and more particularly, to a method and apparatus for a scheduling request (SR) transmission considering a next pre-scheduling uplink (UL) resource and a contention based (CB) UL resource.

### BACKGROUND

There are several UL transmission procedures for Long-Term Evolution (LTE). For example, FIG. 1 shows a schematic view of a legacy SR based UL grant procedure (hereinafter “SR procedure”). When a user equipment (UE) 11 receives packet data units (PDUs) at the Media Access Control (MAC) layer from upper layers, the UE 11 triggers a Buffer Status Report (BSR) for an UL data transmission to an base station (e.g. an eNode B (eNB)) 12. If there is no UL resource at a current transmission time interval (TTI) for transmitting the BSR to the base station 12, the UE 11 triggers a SR to notify the base station 12 to allocate an UL resource. After receiving the SR, the base station 12 will grant an UL resource (i.e., the base station 12 allocates an UL grant to the UE 11) at least for the BSR transmission and perhaps for further data transmission. After receiving the BSR, the base station 12 will grant UL resources to the UE 11 for transmitting leftover data (i.e., the remaining data).

To shorten the latency of the UL transmission, 3GPP RAN2 study item “Study on latency reduction techniques for LTE” proposes a pre-scheduling scheme for fast UL transmission. According to the proposal, as shown in FIG. 2, the base station 22 will periodically allocate a pre-scheduling UL grant for the UE 21 (hereinafter “pre-scheduling scheme”) such that the UE 21 can transmit data on the pre-scheduling resource without using the SR procedure. According to the proposal, the latency of UL transmission can be reduced from 14/9.5TTI (10/1 ms SR period) in a SR procedure to 5.5TTI (1 ms fast UL interval) in a pre-scheduling scheme as shown in TABLEs 1 and 2. TABLE 1 is a referenced UL transmission latency of a SR procedure. TABLE 2 is a referenced UL transmission latency of a pre-scheduling scheme.

TABLE 1

| | | Time |
|---|---|---|
| Component | Description | (ms) |
| 1 | Average waiting time for PUCCH | 5/0.5 |
| | (10/1 ms SR period) | |
| 2 | UE sends Scheduling Request on PUCCH | 1 |
| 3 | eNB decodes Scheduling Request and | 3 |
| | generates the Scheduling Grant | |
| 4 | Transmission of Scheduling Grant | 1 |
| 5 | UE Processing Delay (decoding of scheduling | 3 |
| | grant + L1 encoding of UL data) | |
| 6 | Transmission of UL data | 1 |
| | Total delay [ms] | 14/9.5 |

TABLE 2

| | | Time |
|---|---|---|
| Component | Description | (ms) |
| 1 | Average waiting time to TTI border | 0.5 |
| 2 | eNB transmits UL grant on PDCCH | 1 |
| 3 | UE Processing Delay (decoding of scheduling | 3 |
| | grant + L1 encoding of UL data) | |
| 4 | Transmission of UL data | 1 |
| | Total delay [ms] | 5.5 |

Furthermore, 3GPP RAN2 study item “Uplink latency reduction for synchronized UEs” proposes a CB UL transmission (hereinafter “CB UL transmission”) to assign one Physical Uplink Shared Channel (PUSCH) resource to multiple UEs in the pre-scheduling scheme so as to achieve the statistical multiplexing and to alleviate the problem of unnecessary uplink PUSCH resource waste for the pre-scheduling scheme. Although the CB UL transmission allows more efficient PUSCH resource utilization compared to the pre-scheduling scheme due to collision among the UEs, the potential retransmissions may result in increased latency for colliding UEs.

To meet the requirement of Vehicle-to-Everything (V2X) critical service (i.e., 20 ms of end-to-end latency), it would be better to allocate the UL resource for each UE in the period shorter than 20 ms in a pre-scheduling scheme or to allocate the CB UL resource for UEs in the period shorter than 12 ms in a CB UL transmission. When the UL resources are allocated frequently to meet a shorter period, it is important to consider the UL transmission latency relationship among a SR procedure, a pre-scheduling scheme and a CB UL transmission. If a UE transmits a SR to a base station only based on the UL resource at the current TTI, the base station will allocate unnecessary UL resource, and the radio resource utilization will be degraded.

### SUMMARY

To address the aforesaid problem, a new transmission scheme for SR transmission considering the next pre-scheduling UL resource and a CB UL resource is provided. In the new transmission scheme, the UL transmission latency relationship among a SR procedure, a pre-scheduling scheme and a CB UL transmission is considered, so as to achieve low latency, low power consumption, and more efficient radio resource allocation.

The disclosure includes a wireless communication resource scheduling method, which may comprise: (a) triggering, by an user equipment (UE), a buffer status report (BSR) for an uplink (UL) data transmission; (b) when there is no UL resource for transmitting the BSR at a current transmission time interval (TTI), determining, by the UE, whether to transmit a scheduling request (SR) to an base station at the current TTI by considering a plurality of requirements including: whether a first estimated time period to transmit a first data using a dedicated UL resource requested by the SR is shorter than a second estimated time period to transmit the first data using a next available pre-scheduling UL resource, wherein a probability of a collision between two or more UEs is a factor of determining the second estimated time period; and whether the next available pre-scheduling UL resource is enough to transmit the BSR; and (c) transmitting, by the UE, the BSR using the dedicated UL resource or the next available pre-scheduling UL resource based on a determination of the step (b).

The disclosure also includes a wireless communication resource scheduling method, which may comprise: (a) receiving, by an base station, a scheduling request (SR) from a user equipment (UE); (b) receiving, by the base station, at least one buffer status report (BSR) from the UE after receipt of the SR; (c) determining, by the base station, whether the at least one buffer status report (BSR) is received within a predetermined period after receipt of the SR; and (d) selectively transmitting, by the base station, either one or two uplink (UL) scheduling grants to the UE based on a determination of the step (c).

The disclosure further includes a user equipment (UE) for scheduling wireless communication resource, which may comprise: a transceiver; and a processor coupled to the transceiver and configured to trigger a buffer status report (BSR) for an uplink (UL) data transmission, wherein when there is no UL resource for transmitting the BSR at a current transmission time interval (TTI), the processor is configured to determine whether to transmit a scheduling request (SR) to an base station at the current TTI by considering a plurality of requirements including: whether a first estimated time period to transmit a first data using a dedicated UL resource requested by the SR is shorter than a second estimated time period to transmit the first data using a next available pre-scheduling UL resource, wherein a probability of a collision between two or more UEs is a factor of determining the second estimated time period; and whether the next available pre-scheduling UL resource is enough to transmit the BSR; wherein the transceiver is configured to transmit the BSR using the dedicated UL resource or the next available pre-scheduling UL resource based on a determination of the processor of whether to transmit the SR to the base station at the current TTI.

The disclosure additionally includes a base station for scheduling wireless communication resource, which may comprise: a transceiver configured to receive a scheduling request (SR) and at least one buffer status report (BSR) from a user equipment (UE); and a processor coupled to the transceiver and configured to determine, when the transceiver receives at least one buffer status report (BSR) from the UE after receipt of the SR, whether the at least one buffer status report (BSR) is received within a predetermined period after receipt of the SR; wherein the transceiver is configured to selectively transmit either one or two uplink (UL) scheduling grants to the UE based on a determination of the processor of whether the at least one buffer status report (BSR) is received within the predetermined period after receipt of the SR.

Scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of a legacy SR based UL grant procedure;

FIG. 2 is a schematic view of a legacy pre-scheduling scheme;

FIG. 3 is a block diagram of a UE for scheduling wireless communication resource according to the first embodiment of the present invention;

FIG. 4 is a block diagram of a base station for scheduling wireless communication resource according to the first embodiment of the present invention;

FIG. 5 is a flowchart of a wireless communication resource scheduling method according to the first embodiment of the present invention;

FIG. 6 is a flowchart of the Steps 504-505 in FIG. 5 according to the first embodiment of the present invention;

FIG. 7 is a schematic view of a SR based UL grant procedure according to the first embodiment of the present invention;

FIG. 8 is a schematic view of a pre-scheduling scheme according to the first embodiment of the present invention;

FIG. 9 is a schematic view of a CB UL transmission according to the first embodiment of the present invention;

FIG. 10 is a schematic view of a SR based UL grant procedure according to the first embodiment of the present invention;

FIG. 11 is a schematic view of a pre-scheduling scheme according to the first embodiment of the present invention;

FIG. 12 is a schematic view of a CB UL transmission according to the first embodiment of the present invention;

FIG. 13 is a schematic view of a SR based UL grant procedure according to the first embodiment of the present invention;

FIG. 14 is a schematic view of a CB UL transmission according to the first embodiment of the present invention;

FIG. 15 is an another flowchart of the Steps 504-505 in FIG. 5 according to the second embodiment of the present invention;

FIG. 16 is an another flowchart of the Steps 504-505 in FIG. 5 according to the third embodiment of the present invention;

FIG. 17 is a flowchart of a SR and BSR procedure at the base station side according to an embodiment of the present invention; and

FIG. 18 is a schematic view of a SR based UL grant procedure according to the embodiment in FIG. 17.

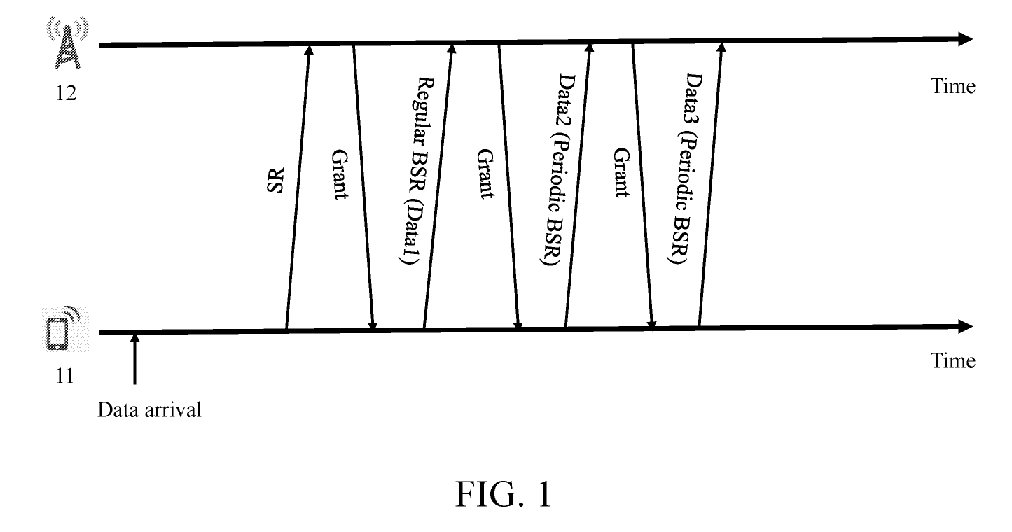

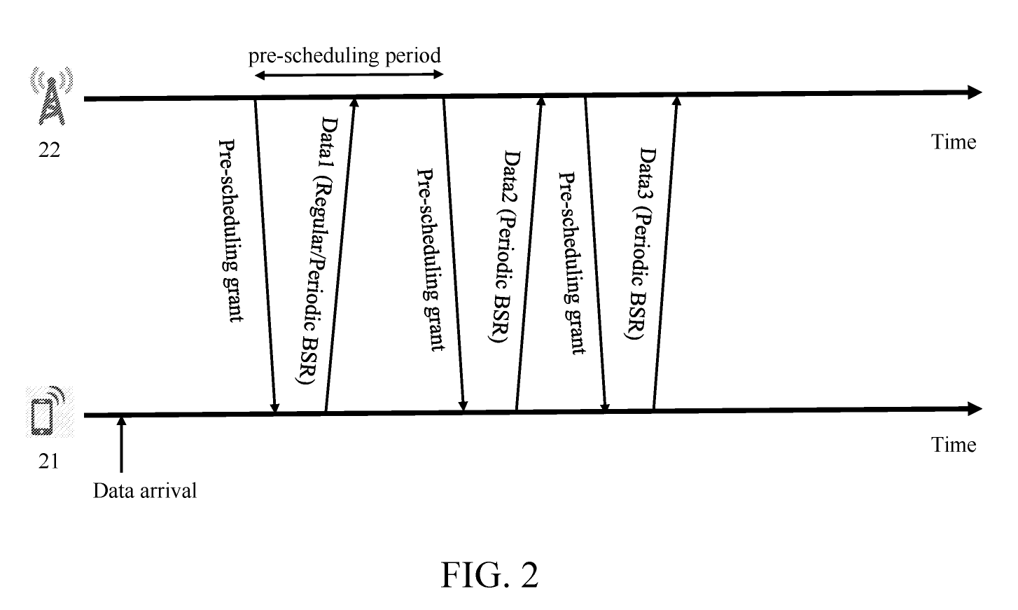

### DETAILED DESCRIPTION

In the following description, the present invention will be explained with reference to certain example embodiments thereof. However, these example embodiments are not intended to limit the present invention to any specific examples, embodiments, environment, applications or particular implementations described in these embodiments. Therefore, description of these example embodiments is only for purpose of illustration rather than to limit the present invention, and the scope of this application shall be governed by the claims.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

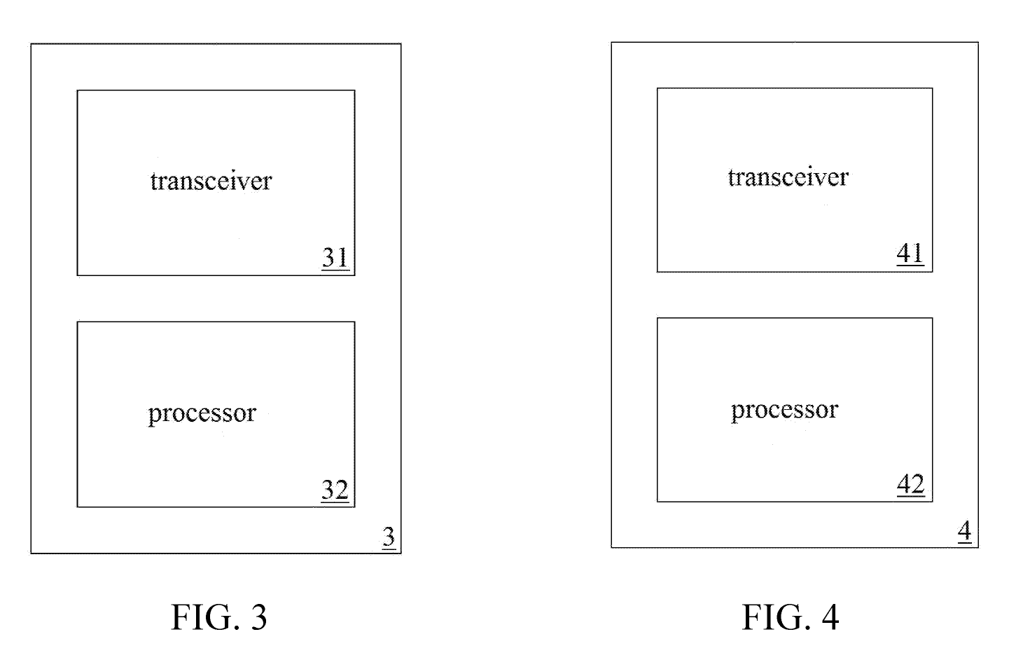

FIG. 3 is a block diagram of a user equipment (UE) 3 for scheduling wireless communication resource according to the first embodiment of the present invention. The UE 3 comprises a transceiver 31 and a processor 32. The UE 3 can be a mobile station, for example. The processor 32 is coupled to the transceiver 31. The transceiver 31 is configured to transmit and receive signals or data. The processor 32 is configured to trigger a buffer status report (BSR), and to determine whether to transmit a scheduling request (SR) to a base station. FIG. 4 is a block diagram of a base station 4 for scheduling wireless communication resource according to the first embodiment of the present invention. The base station 4 comprises a transceiver 41 and a processor 42. The base station 4 can be an eNode B (eNB) for LTE, for example. The processor 42 is coupled to the transceiver 41. The transceiver 41 is configured to transmit and receive signals or data. The processor 42 is configured to configure and activate the pre-scheduling resource, and to determine whether at least one BSR is received within a predetermined period after receipt of an SR. The interactions among the UE 3 and the base station 4 will be further described hereinbelow.

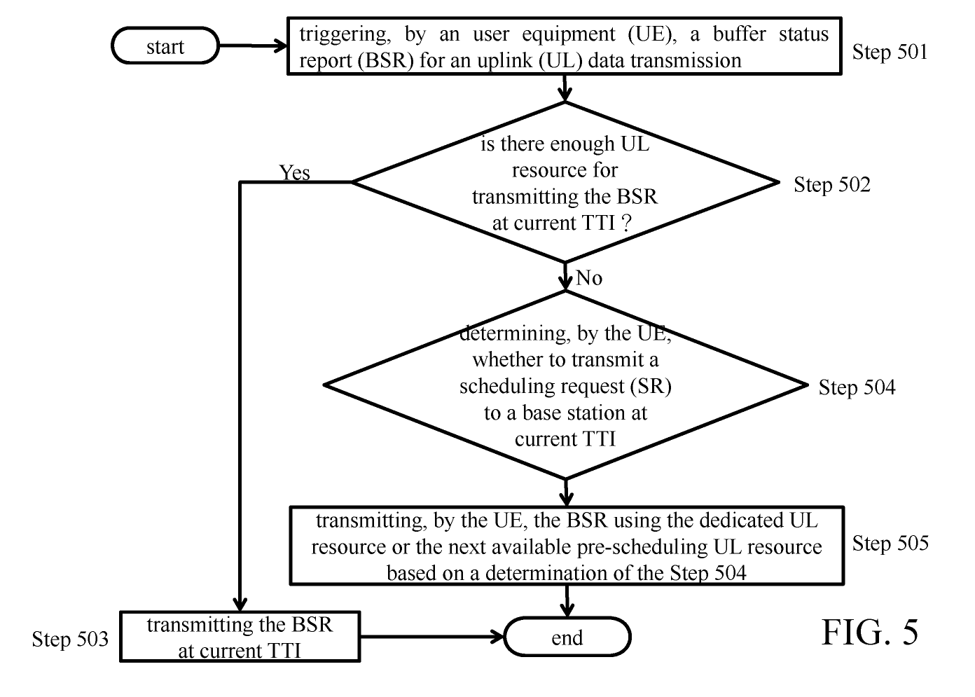

Regarding an uplink (UL) data transmission, first, a base station configures and activates the pre-scheduling resource (e.g., pre-scheduling interval, offset, Transport Block (TB) size, etc) for a UE. When the UE receives packet data units (PDUs) at Media Access Control (MAC) layer from upper layers, the UE will trigger a BSR for an UL data transmission. FIG. 5 is a flowchart of a wireless communication resource scheduling method according to the first embodiment of the present invention, which includes the steps as follows:

Step 501: a user equipment (UE) triggers a buffer status report (BSR) for an uplink (UL) data transmission;

Step 502: the UE checks whether there is enough UL resource for transmitting the BSR at a current transmission time interval (TTI);

Step 503: the UE transmits the BSR at the current TTI if there is enough UL resource;

Step 504: when there is no UL resource for transmitting the BSR at the current TTI, the UE determines whether to transmit a scheduling request (SR) to a base station at the current TTI; and

Step 505: the UE transmits the BSR using the dedicated UL resource or the next available pre-scheduling UL resource based on the determination of Step 504.

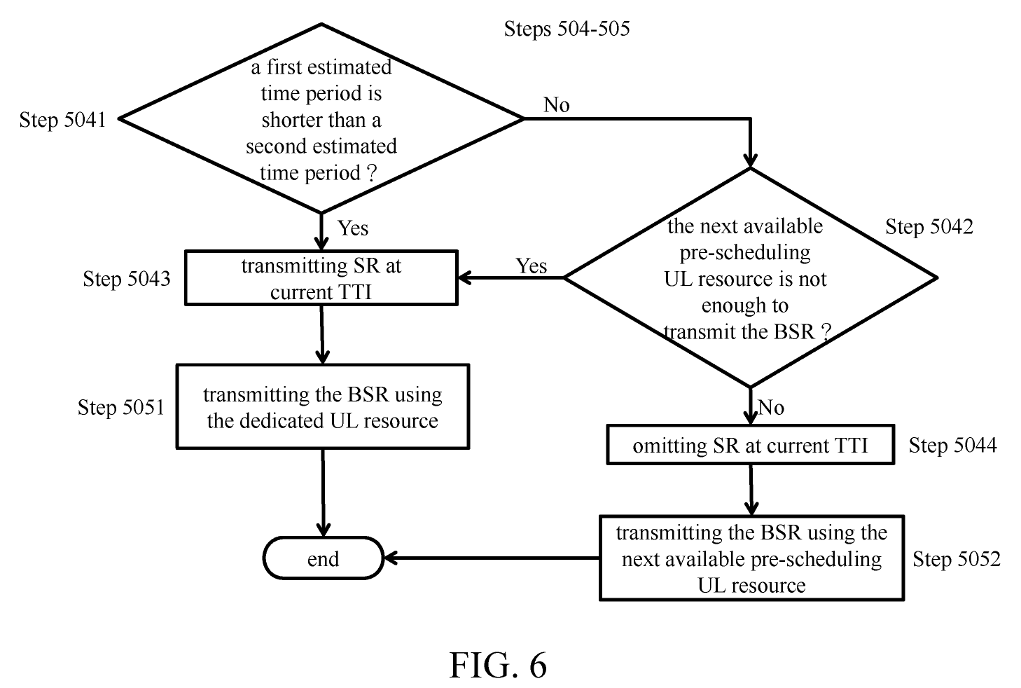

FIG. 6 illustrates an embodiment of Steps 504-505. In an embodiment as shown in FIG. 6, the UE determines whether to transmit a SR to the base station at the current TTI by considering a plurality of requirements (1)-(2) as follows:

(1) Step S041: whether a first estimated time period to transmit a first data using a dedicated UL resource requested by the SR (i.e., a SR procedure) is shorter than a second estimated time period to transmit the first data using a next available pre-scheduling UL resource (i.e., a pre-scheduling scheme or a CB UL transmission), wherein a probability of a collision between two or more UEs is a factor of determining the second estimated time period.

(2) Step S042: whether the next available pre-scheduling UL resource is enough to transmit the B SR.

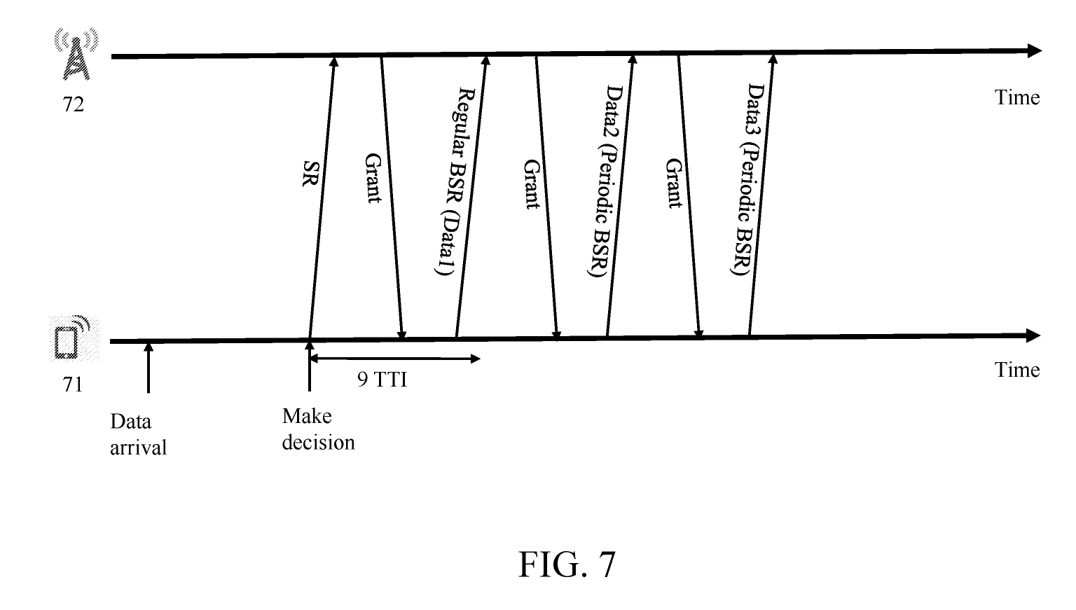

In an embodiment, the first estimated time period in Step S041 is an estimate of a time interval starting when the UE 71 starts to transmit the SR to the base station 72 and ending when the base station 72 receives the first data from the UE 71 in the SR procedure. For example, the first estimated time period is 9TTI in the example shown in FIG. 7 according to TABLE 1, and the UE 71 needs 9TTI to transmit the first data, wherein the 9TTI is counted from the components 2-6 in TABLE 1.

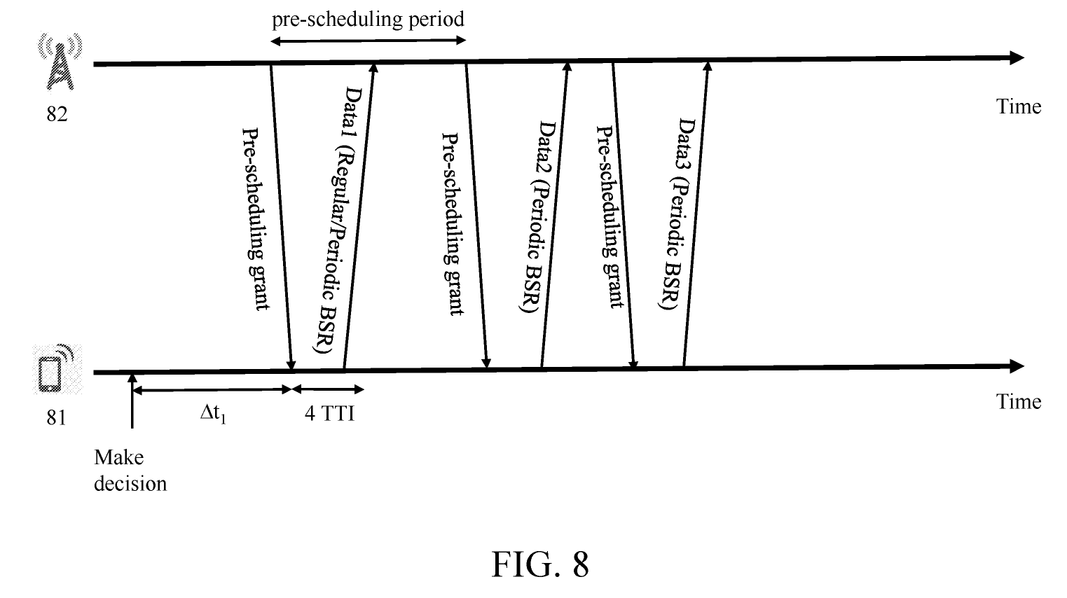

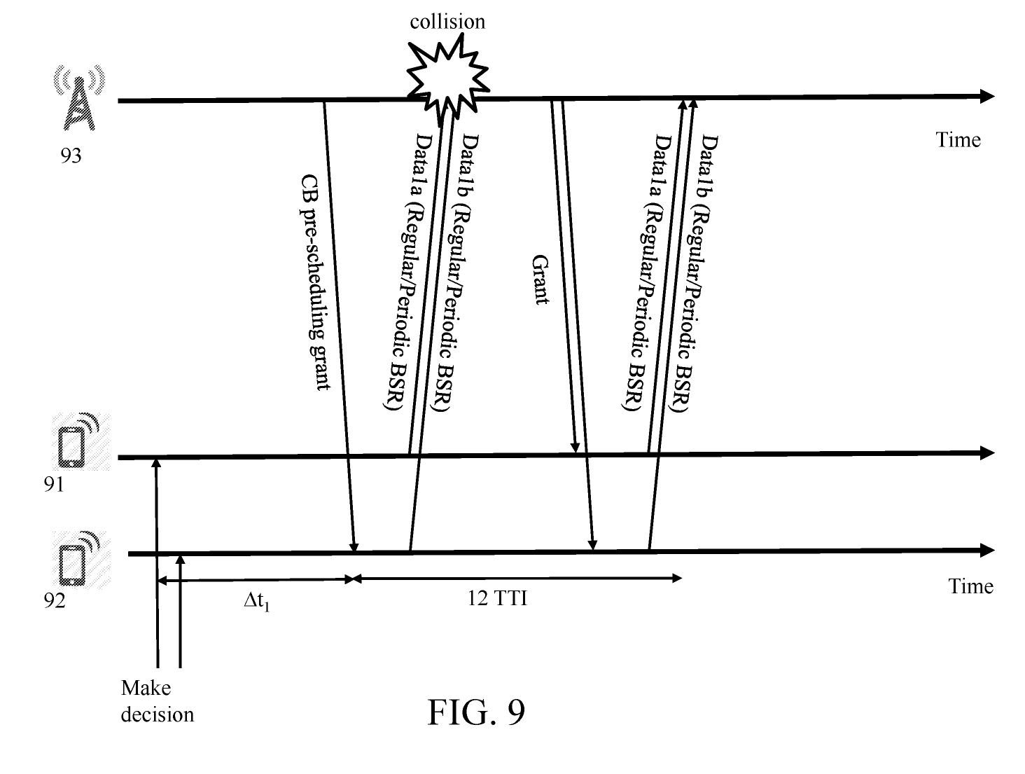

In an embodiment, the second estimated time period in Step S041 includes a third estimated time period and a fourth estimated time period, wherein the third estimated time period is an estimate of a first time interval between the current TTI and when the UE (81, 91, 92) receives an immediately next pre-scheduling UL resource. For example, the third estimated time period is Δt₁ in the examples shown in FIGS. 8-9, which is an average waiting time (e.g., the component 1 in TABLE 2) from the current TTI to the immediately next pre-scheduling UL resource. For example, as shown in TABLE 2, the pre-scheduling period is 1 ms, and the average waiting time is 0.5 ms, i.e., a half of the pre-scheduling period.

Furthermore, as shown in the example in FIG. 8, the immediately next pre-scheduling UL resource is available to the UE 81 to successfully transmit the first data to the base station 82 in a pre-scheduling scheme, because the base station 82 will allocate one separate pre-scheduling UL grant for each UE 81 in each pre-scheduling interval periodically as shown in FIG. 8. However, as shown in the example in FIG. 9, in a CB UL transmission, the immediately next pre-scheduling UL resource (i.e. the CB pre-scheduling UL grant as shown in FIG. 9) may not be available to the UEs (91, 92) to successfully transmit the first data to the base station 93 when a collision happens if two or more UEs (91, 92) share the same PUSCH resource and perform the PUSCH transmission at the same time as shown in FIG. 9. Therefore, after a collision happens, the base station 93 will allocate one separate UL grant available (seen as a next available pre-scheduling UL resource) to each UE (91, 92) for successful retransmission to avoid further collision.

In an embodiment, the fourth estimated time period is an estimate of a second time interval starting when the UE (81, 91, 92) receives the immediately next pre-scheduling UL resource and ending when the base station (82, 93) receives the first data from the UE (81, 91, 92). As shown the example in FIG. 8, in a pre-scheduling scheme, the actual second time interval starting when the UE 81 receives the immediately next pre-scheduling UL resource and ending when the base station 82 receives the first data from the UE 81 is 4TTI and the UE 81 needs Δt₁+4TTI to transmit the first data as shown in FIG. 8, and the 4TTI is counted from the components 3-4 in TABLE 2). As shown in the example in FIG. 9, in a CB UL transmission, the actual second time interval starting when the UE (91, 92) receives the immediately next pre-scheduling UL resource and ending when the base station 93 receives the first data from the UE (91, 92) is 12TTI and the UE (91, 92) needs Δt₁+12TTI to successfully transmit the first data when a collision happens as shown in FIG. 9, and the 12TTI is counted from the components 3-4 in TABLE 2 plus the components 3-6 in TABLE 1) using the next available pre-scheduling UL resource. Therefore, compared to the pre-scheduling scheme, it takes additional 8TTI for UE (91, 92) to successfully transmit the first data, because the base station 93 needs to allocate separate one UL grant to UEs (91, 92) for data retransmission when a collision happens in a CB UL transmission.

In order to estimate the second time interval starting when the UE (81, 91, 92) receives the immediately next pre-scheduling UL resource and ending when the base station (82, 93) receives the first data from the UE (81, 91, 92), a probability P of a collision between two or more UEs (91, 92) is used as a factor of determining the second estimated time period in a pre-scheduling scheme and a CB UL transmission. Specifically, the collision probability P is used to estimate the second time interval (as the fourth estimated time period) to consider the pre-scheduling scheme and the CB UL transmission. For example, 4TTI+P*8TTI is an estimate of the second time interval (i.e., the fourth estimated time period), and it is estimated that the UE (or multiple UEs) (81, 91, 92) needs Δt₁+4TTI+P*8TTI to transmit the first data in either a pre-scheduling scheme or a CB UL transmission using the next available pre-scheduling UL resource. When the collision probability P equals to zero, it means no collision happens as shown in FIG. 8. When the collision probability P equals to 1, it means a collision happens as shown in FIG. 9.

In an embodiment, the collision probability P can be estimated by the UE (81, 91, 92) according to a collision rate of several pre-scheduling periods. For example, if the UE (81, 91, 92) tracks the past three pre-scheduling periods and finds one collision happens, the collision probability P is estimated by the UE (81, 91, 92) to be 1/3. In another embodiment, the collision probability P can also be estimated by the base station (82, 93) according to a collision rate of several pre-scheduling periods and be transmitted to the UE (81, 91, 92). For example, if the base station (82, 93) tracks the past three pre-scheduling periods and finds one collision happens, the collision probability P is estimated by the base station (82, 93) to be 1/3 and be transmitted to the UE (81, 91, 92).

Then, the first estimated time period is compared to the second estimated time period in Step S041 in the requirement (1) (for example, 9TTI<Δt₁+4TTI+P*8TTI?). When the first estimated time period is shorter than the second estimated time period, it means that the estimated UL transmission latency for transmitting the first data in an SR procedure is shorter than one in either a pre-scheduling scheme or a CB UL transmission. Therefore, an SR procedure (Step S043, Step S051) can be considered for shorter UL transmission latency.

In an embodiment, the UE (81, 91) in Step S042 will check whether the next available pre-scheduling UL resource is enough to transmit the BSR as follows:

(pre-scheduling resource)−(MAC header)−(buffered data with higher priority logical channel)<short BSR?

wherein the short BSR is a type of BSR with minimum size.

If (pre-scheduling resource)−(MAC header)−(buffered data with higher priority logical channel)<short BSR, it means that the next available pre-scheduling UL resource is not enough to transmit the BSR. Therefore, an SR procedure (Step S043, Step S051) can be considered to request UL resource.

In view of the above, there are three possible scenarios when considering the two requirements (1)-(2) (Step S041, Step S042) in the first embodiment of the present invention.

Scenario 1: The UE transmits the SR to the base station in Step S043 when the first estimated time period is shorter than the second estimated time period in Step S041, and then the UE transmits the BSR using the dedicated UL resource in Step S051. Specifically, a SR procedure is chosen for shorter UL transmission latency.

Scenario 2: the UE transmits the BSR using the next available pre-scheduling UL resource in Step S052 without transmitting the SR to the base station (Step S044) when the first estimated time period is not shorter than the second estimated time period in Step S041 and when the next available pre-scheduling UL resource is enough to transmit the BSR in Step S042. Specifically, the UE does not need to transmit the SR at the current TTI because the BSR can be transmitted on the next available pre-scheduling resource and the UL transmission latency will not be increased.

Scenario 3: the UE transmits the SR to the base station in Step S043 when the first estimated time period is not shorter than the second estimated time period in Step S041 but the next available pre-scheduling UL resource is not enough to transmit the BSR in Step S042, and then the UE transmits the BSR using the dedicated UL resource in Step S051.

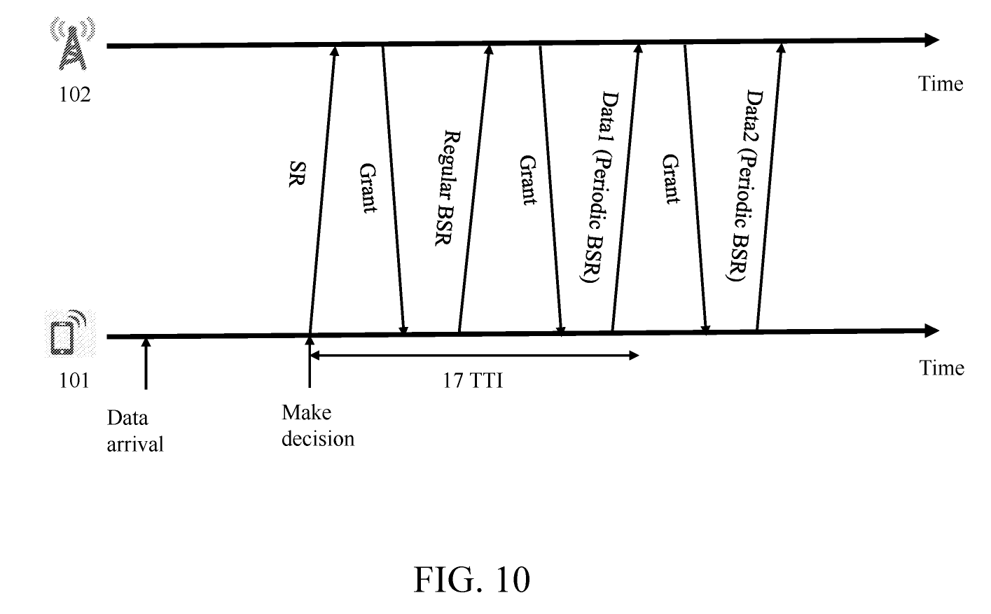

Regarding the first embodiment above of the present invention, in some cases, the first estimated time period in the SR procedure in Step S041 in requirement (1) takes more time for the reason as follows. As shown in FIG. 10, when the base station 102 receives the SR from the UE 101, the base station 102 has no idea about how much data the UE 101 will transmit. To increase the radio resource utilization, the base station 102 initially allocates limited resource for the UE 101 to only transmit the BSR. After receiving the BSR, the base station 102 allocates dedicated UL resource requested by the SR for the UE 101 to transmit the first data. Therefore, it needs one more round trip for the UE 101 to transmit the first data. For example, the first estimated time period is 17TTI as shown in FIG. 10 according to TABLE 1. It means that the UE 101 needs 17TTI to transmit the first data, wherein the 17TTI is counted by the sum of 9TTI (from the components 2-6 in TABLE 1) and 8TTI (from the components 3-6 in TABLE 1). Therefore, the first estimated time period is compared to the second estimated time period in Step S041 in the requirement (1) can be modified to 17TTI<Δt₁+4TTI+P*8TTI?, for example.

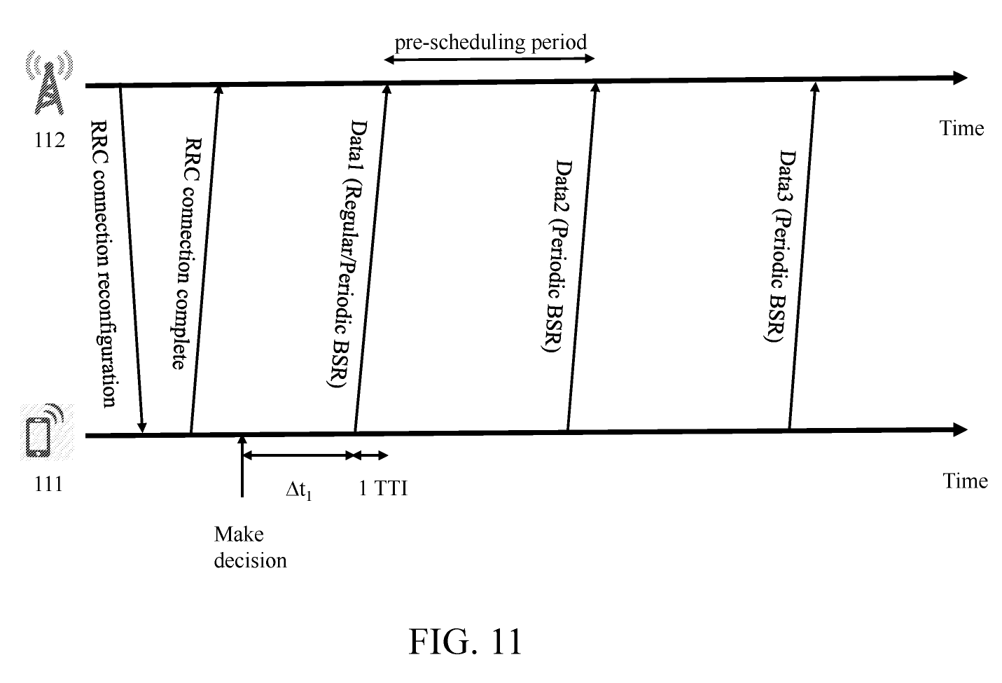

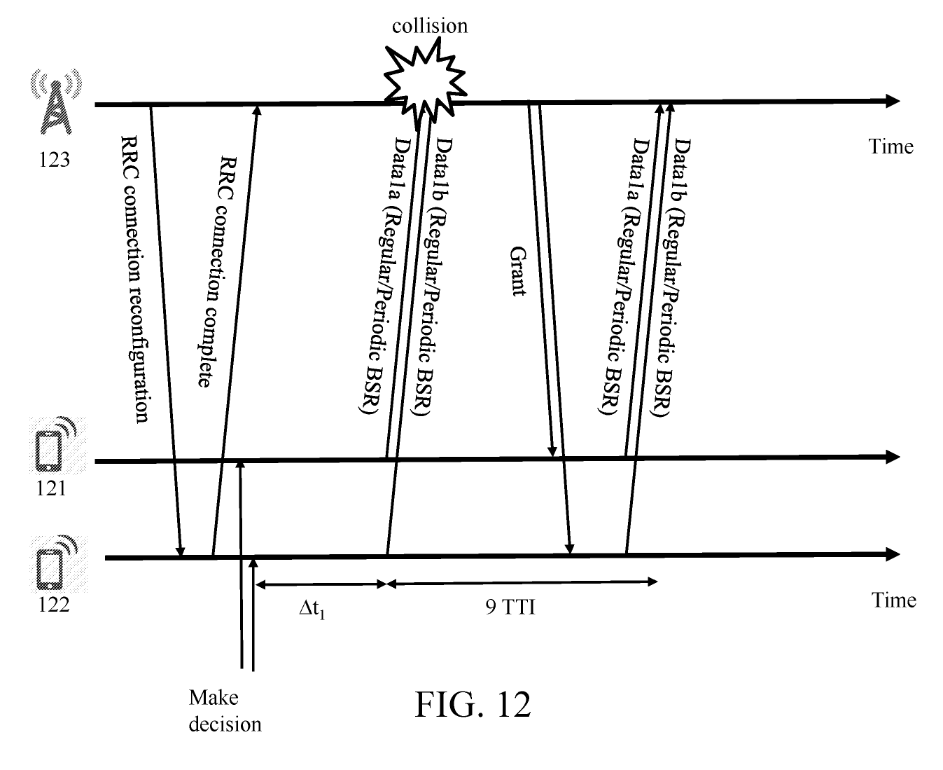

Regarding the first embodiment above of the present invention, in some cases the second estimated time period in the pre-scheduling scheme or CB UL transmission in Step S041 in requirement (1) takes less time for the reason as follows. As shown in FIGS. 11-12, because the base station (112, 123) configures Semi-Persistent Scheduling (SPS) configuration including SPS interval, resource start, resource end, and etc., the UE (111, 121, 122) does not need to read the PUCCH to identify the resource of a subframe, and therefore needs less time to transmit the first data (i.e. the UE (111, 121, 122) does not need to decode the immediately next pre-scheduling UL resource such that the latency component 3 in TABLE 2 can be reduced).

Therefore, the first estimated time period is compared to the second estimated time period in Step S041 in the requirement (1) can be modified to 9TTI<Δt₁+1TTI+P*8TTI?, for example.

In an embodiment, the first estimated time period in the SR procedure and the fourth estimated time period in the CB UL transmission in Step S041 in the requirement (1) can be estimated statistically. Sometimes the base station may not grant UL resource at a specific TTI because of lacking of radio resource, and there is an uncertainty between the SR reception and the UL resource grant. This embodiment is the general case that (i) the time interval of granting UL resource after receiving SR is estimated by the statistics of the past pre-scheduling periods in the SR procedure, and (ii) the time interval of granting UL resources after collision is estimated by the statistics of the past CB pre-scheduling periods in a CB UL transmission.

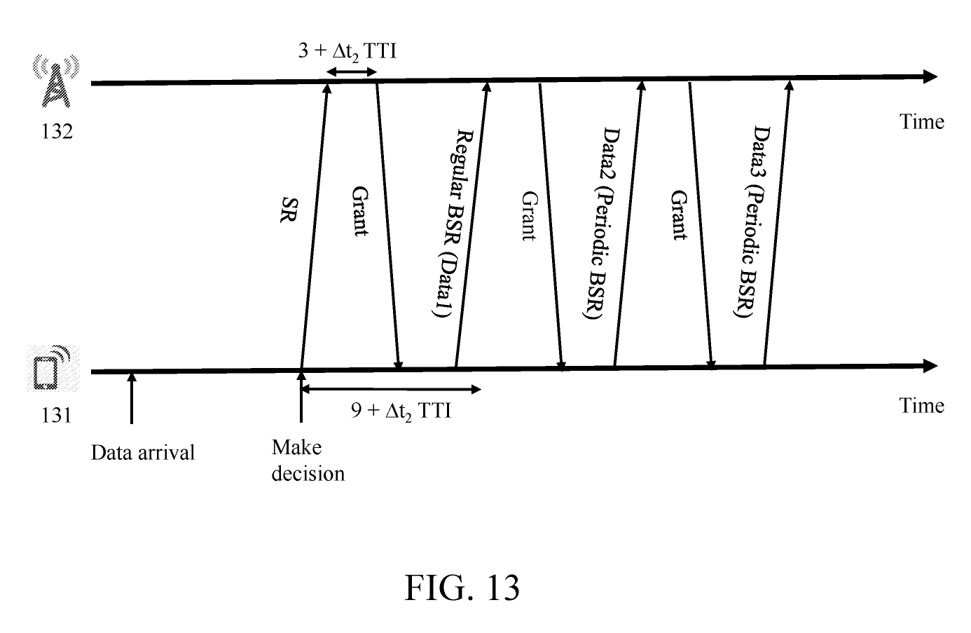

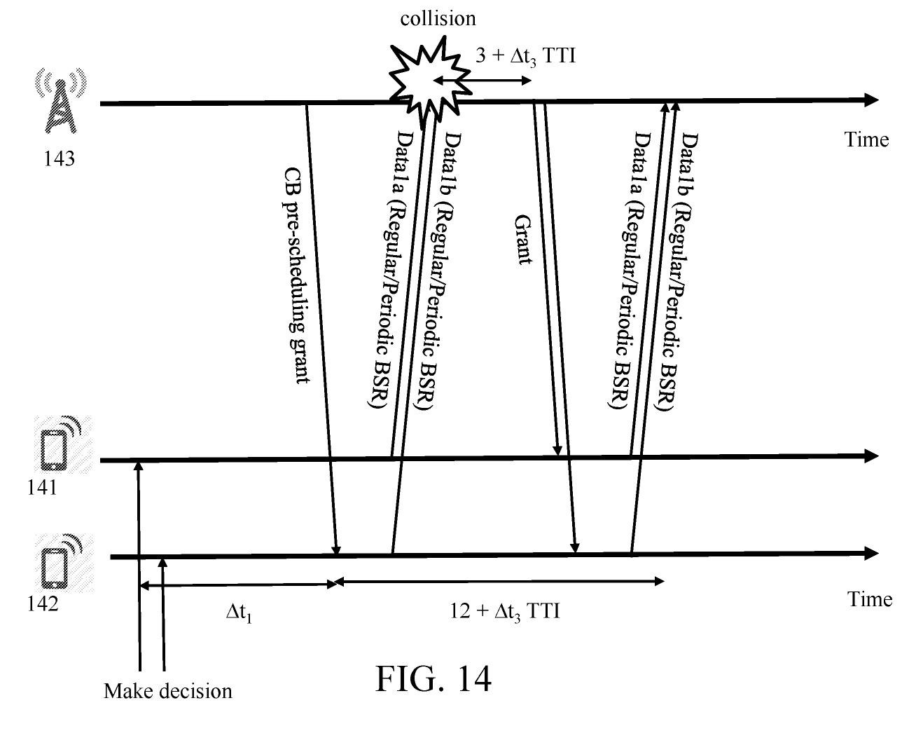

As shown in FIG. 13, for example, the first estimated time period can also be (9+Δt₂)TTI, wherein the (3+Δt₂)TTI is the estimated time that the base station 132 grants UL resource after receiving SR rather than referenced 3TTI from the component 3 in TABLE 1. The Δt₂ is used to adjust the referenced 3TTI because of an uncertainty of the time interval of granting UL resource after receiving SR. The UE 131 or the base station 132 can track the past several pre-scheduling periods to calculate the adjustment value Δtₜ. As shown in FIG. 14, for example, the fourth estimated time period can also be (12+Δt₃)TTI, wherein (3+Δt₃)TTI is the estimated time that the base station 143 grants UL resources after collision happens rather than referenced 3TTI from the components 3 in TABLE 1. Similarly, the Δt₃ is used to adjust the referenced 3TTI because of an uncertainty of the time interval of granting UL resources after collision. The UE (141, 142) or the base station 143 can track the past several pre-scheduling periods with collision to calculate the adjustment value Δt₃. Therefore, the UE (or multiple UEs) (131, 141, 142) needs Δt₁+4TTI+P*(8+Δt₃)TTI to transmit the first data in either a pre-scheduling scheme or a CB UL transmission using the next available pre-scheduling UL resource. When the collision probability P equals to zero, it means no collision happens. When the collision probability P equals to 1, it means a collision happens as shown in FIG. 14. Therefore, the first estimated time period is compared to the second estimated time period in Step S041 in the requirement (1) can be modified to 9TTI+Δt₂TTI<Δt₁+4TTI+P*(8+Δt₃)TTI?, for example.

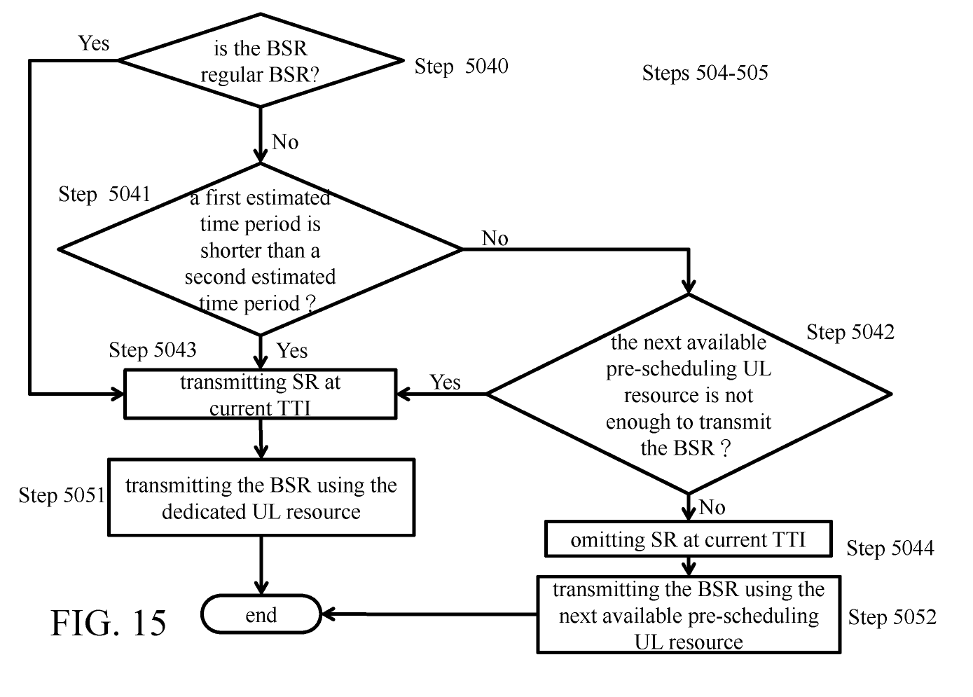

FIG. 15 illustrates the second embodiment of Steps 504-505 in FIG. 5. This embodiment is similar to the first embodiment shown in FIG. 6. Compared to the first embodiment as shown in FIG. 6, the UE determines whether to transmit a SR to the base station at the current TTI further considering another requirement:

(3) Step S040: whether the BSR is a regular BSR.

In particular, it is possible that data with high priority arrives during the current TTI and the next pre-scheduling UL resource such that there may be no UL resource for transmitting BSR on the next pre-scheduling UL resource. To prevent the condition that UE cannot transmit SR continuously, one of the solutions is to check whether the BSR is a regular BSR or a periodic/padding BSR. Because a regular BSR is mainly for initialization of a bearer, the UE should transmit SR anyway without considering the next pre-scheduling UL resource. However, the periodic/padding BSR is mainly for continuation transmission of large file, the UE may omit the SR and follow the procedure of the first embodiment. Specifically, this embodiment can achieve more efficient radio resource allocation.

In view of the above, there are four possible scenarios when considering the requirements (1)-(3) (Step S041, Step S042, Step S040) above in the second embodiment of the present invention.

Scenario 1: The UE transmits the SR to the base station in Step S043 when the BSR is a regular BSR (Step S040), and then the UE transmits the BSR using the dedicated UL resource (Step S051).

Scenario 2: the UE transmit the SR to the base station in Step S043 when the BSR is not a regular BSR (Step S040) and when the first estimated time period is shorter than the second estimated time period (Step S041), and then the UE transmits the BSR using the dedicated UL resource in Step S051.

Scenario 3: the UE transmits the BSR using the next available pre-scheduling UL resource in Step S052 without transmitting the SR to the base station (Step S044) when the BSR is not a regular BSR (Step S040), when the first estimated time period is not shorter than the second estimated time period (Step S041), and when the next available pre-scheduling UL resource is enough to transmit the BSR (Step S042).

Scenario 4: the UE transmit the SR to the base station in Step S043 when the BSR is not a regular BSR (Step S040), when the first estimated time period is not shorter than the second estimated time period (Step S041) but the next available pre-scheduling UL resource is not enough to transmit the BSR (Step S042), and then the UE transmits the BSR using the dedicated UL resource (Step S051).

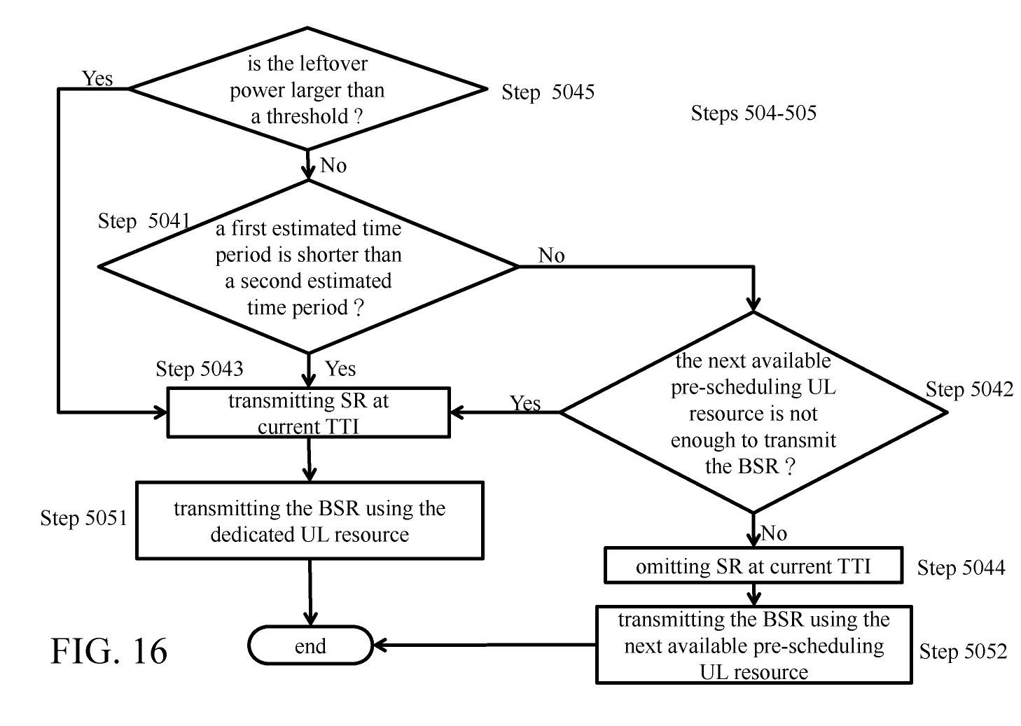

FIG. 16 illustrates the third embodiment of Steps 504-505 in FIG. 5. This embodiment is similar to the first embodiment as shown in FIG. 6. Compared to the first embodiment as shown in FIG. 6, the difference is that the UE determine whether to transmit a SR to the base station at the current TTI further considers another requirement:

(4) Step S045: whether a leftover power of the UE is larger than a threshold.

For machine type communication (MTC) device, low power consumption is an important issue because the battery power may be used for more than ten years. In this embodiment, the leftover power of the UE is a requirement to determine whether to send the SR. For example, when the leftover power of the UE is lower than a threshold (e.g., 50% power headroom), the UE activates the SR omission procedure to achieve low power consumption.

In view of the above, there are four possible scenarios when considering the requirements (1)-(2) and (4) (Step S041, Step S042, Step S045) above in the third embodiment of the present invention.

Scenario 1: The UE transmits the SR to the base station in Step S043 when the leftover power of the UE is larger than the threshold (Step S045), and then the UE transmits the BSR using the dedicated UL resource (Step S051).

Scenario 2: the UE transmit the SR to the base station in Step S043 when the leftover power of the UE is not larger than the threshold (Step S045) and when the first estimated time period is shorter than the second estimated time period (Step S041), and then the UE transmits the BSR using the dedicated UL resource (Step S051).

Scenario 3: the UE transmits the BSR using the next available pre-scheduling UL resource in Step S052 without transmitting the SR to the base station (Step S044) when the leftover power of the UE is not larger than the threshold (Step S045), when the first estimated time period is not shorter than the second estimated time period (Step S041), and when the next available pre-scheduling UL resource is enough to transmit the BSR (Step S042).

Scenario 4: the UE transmit the SR to the base station in Step S043 when the leftover power of the UE is not larger than the threshold (Step S045), when the first estimated time period is not shorter than the second estimated time period (Step S041) but the next available pre-scheduling UL resource is not enough to transmit the BSR (Step S042), and then the UE transmits the BSR using the dedicated UL resource (Step S051).

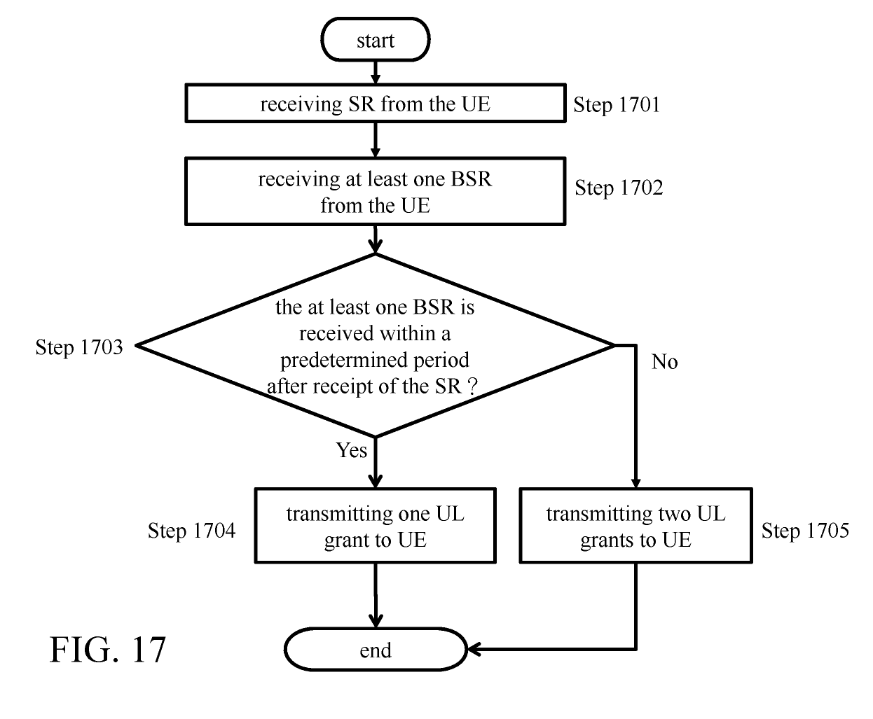

FIG. 17 is a flowchart of an SR and BSR procedure at the base station side according to an embodiment of the present invention. This embodiment provides a wireless communication resource scheduling method as follows. First, a base station configures the SR period for a UE and then the base station configures and activates the pre-scheduling resource (e.g. pre-scheduling interval, offset, Transport Block (TB) size, etc) for the UE. When the base station receives a SR from the UE in Step 1701 and then receives at least one BSR from the UE after receipt of the SR in Step 1702, the base station determines whether the at least one BSR is received within a predetermined period after receipt of the SR in Step 1703. Finally, the base station selectively transmits either one (Step 1704) or two (Step 1705) UL scheduling grants to the UE based on a determination of the Step 1703.

In view of the above, there are two possible scenarios when considering the requirement above in this embodiment of the present invention.

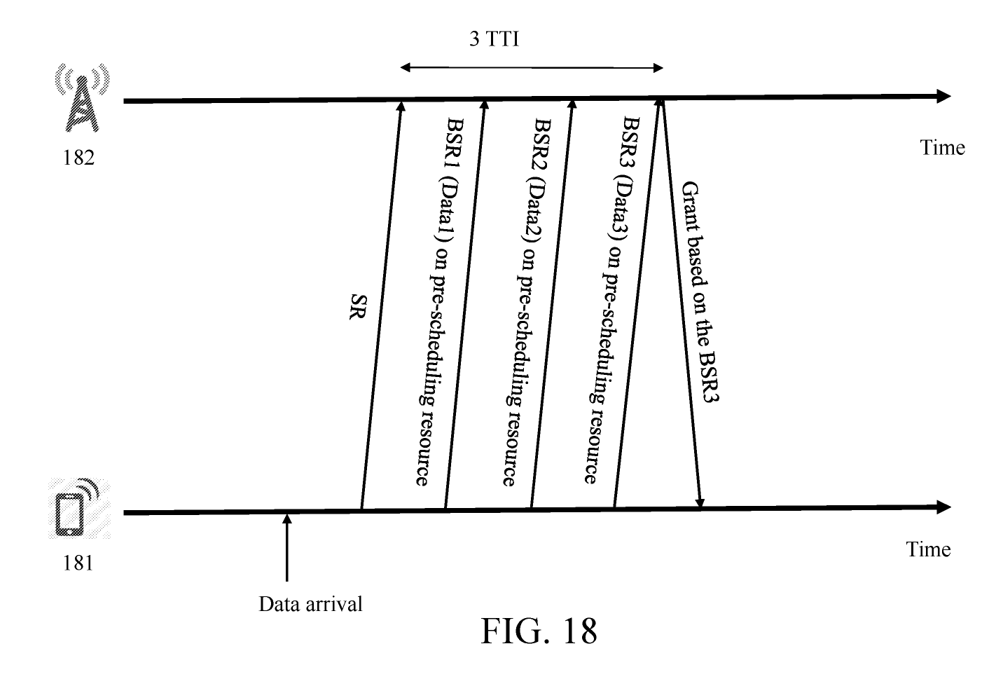

Scenario 1: the base station transmits the one UL scheduling grant to the UE to respond to the at least one BSR without transmitting another UL scheduling grant to the UE to respond to the SR in Step 1704 when the at least one BSR is received within the predetermined period after receipt of the SR (Step 1703). As shown in FIG. 18, for example, the base station 182 receives three BSRs within a predetermined period 3TTI after receipt of the SR. Therefore, the base station 182 transmits only one UL scheduling grant to the UE 181 to respond to the last BSR3 of the three BSRs. Specifically, the base station 182 considers the SR and the BSRs as the same UL resource request and will grant one UL resource other than two UL resources for the UE 181. Thus, it alleviates the problem of unnecessary UL PUSCH resource waste.

Scenario 2: the base station transmits the one UL scheduling grant to the UE to respond to the SR and another one UL scheduling grant to the UE to respond to the at least one BSR in Step 1705 when the at least one buffer status report (BSR) is received not within the predetermined period after receipt of the SR (Step 1703).

In summary, the above embodiments propose a new transmission scheme for SR transmission considering the next pre-scheduling UL resource and a CB UL resource. In the new transmission scheme, the UL transmission latency relationship among a SR procedure, a pre-scheduling scheme and a CB UL transmission is considered, so as to achieve low latency, low power consumption, and more efficient radio resource allocation.

The above disclosure is related to the detailed technical contents and inventive features thereof. People skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless communication resource scheduling method, comprising:
(a) triggering, by an user equipment (UE), a buffer status report (BSR) for an uplink (UL) data transmission;
(b) when there is no UL resource for transmitting the BSR at a current transmission time interval (TTI), determining, by the UE, whether to transmit a scheduling request (SR) to an base station at the current TTI by considering a plurality of requirements including:
whether a first estimated time period to transmit a first data using a dedicated UL resource requested by the SR is shorter than a second estimated time period to transmit the first data using a next available pre-scheduling UL resource, wherein a probability of a collision between two or more UEs is a factor of determining the second estimated time period; and
whether the next available pre-scheduling UL resource is enough to transmit the BSR; and
(c) transmitting, by the UE, the BSR using the dedicated UL resource or the next available pre-scheduling UL resource based on a determination of the step (b).

2. The method of claim 1, wherein the step (b) further comprising: estimating, by the UE, the probability according to a collision rate of several pre-scheduling periods.

3. The method of claim 1, wherein the step (b) further comprising: receiving, by the UE, the probability from the base station which estimates the probability according to a collision rate of several pre-scheduling periods.

4. The method of claim 1, wherein the second estimated time period includes a third estimated time period and a fourth estimated time period, wherein the third estimated time period is an estimate of a first time interval between the current TTI and when the UE receives an immediately next pre-scheduling UL resource, and the fourth estimated time period is an estimate of a second time interval starting when the UE receives the immediately next pre-scheduling UL resource and ending when the base station receives the first data from the UE using the next available pre-scheduling UL resource, wherein the estimate of the second time interval is calculated based on the probability of the collision between two or more UEs.

5. The method of claim 1, wherein the second estimated time period includes a third estimated time period and a fourth estimated time period, wherein the third estimated time period is an estimate of a first time interval between the current TTI and when the UE starts to transmit a first data to the base station, and the fourth estimated time period is an estimate of a second time interval starting when the UE starts to transmit the first data to the base station and ending when the base station receives the first data from the UE using the next available pre-scheduling UL resource, wherein the estimate of the second time interval is calculated based on the probability of the collision between two or more UEs.

6. The method of claim 1, further comprising, after the step (b), transmitting, by the UE, the SR to the base station when the first estimated time period is shorter than the second estimated time period, and the step (c) is performed by transmitting, by the UE, the BSR using the dedicated UL resource.

7. The method of claim 1, wherein the step (c) is performed by transmitting, by the UE, the BSR using the next available pre-scheduling UL resource without transmitting the SR to the base station when the first estimated time period is not shorter than the second estimated time period and when the next available pre-scheduling UL resource is enough to transmit the BSR.

8. The method of claim 1, further comprising, after the step (b), transmitting, by the UE, the SR to the base station when the first estimated time period is not shorter than the second estimated time period but the next available pre-scheduling UL resource is not enough to transmit the BSR, and the step (c) is performed by transmitting, by the UE, the BSR using the dedicated UL resource.

9. The method of claim 1, wherein the plurality of requirements further include whether the BSR is a regular BSR.

10. The method of claim 9, further comprising, after the step (b), transmitting, by the UE, the SR to the base station when the BSR is a regular BSR, and the step (c) is performed by transmitting, by the UE, the BSR using the dedicated UL resource.

11. The method of claim 9, further comprising, after the step (b), transmitting, by the UE, the SR to the base station when the BSR is not a regular BSR and when the first estimated time period is shorter than the second estimated time period, and the step (c) is performed by transmitting, by the UE, the BSR using the dedicated UL resource.

12. The method of claim 9, wherein the step (c) is performed by transmitting, by the UE, the BSR using the next available pre-scheduling UL resource without transmitting the SR to the base station when the BSR is not a regular BSR, when the first estimated time period is not shorter than the second estimated time period, and when the next available pre-scheduling UL resource is enough to transmit the BSR.

13. The method of claim 9, further comprising, after the step (b), transmitting, by the UE, the SR to the base station when the BSR is not a regular BSR, when the first estimated time period is not shorter than the second estimated time period but the next available pre-scheduling UL resource is not enough to transmit the BSR, and the step (c) is performed by transmitting, by the UE, the BSR using the dedicated UL resource.

14. The method of claim 1, wherein the plurality of requirements further include whether a leftover power of the UE is larger than a threshold.

15. The method of claim 14, further comprising, after the step (b), transmitting, by the UE, the SR to the base station when the leftover power of the UE is larger than the threshold, and the step (c) is performed by transmitting, by the UE, the BSR using the dedicated UL resource.

16. The method of claim 14, further comprising, after the step (b), transmitting, by the UE, the SR to the base station when the leftover power of the UE is not larger than the threshold and when the first estimated time period is shorter than the second estimated time period, and the step (c) is performed by transmitting, by the UE, the BSR using the dedicated UL resource.

17. The method of claim 14, wherein the step (c) is performed by transmitting, by the UE, the BSR using the next available pre-scheduling UL resource without transmitting the SR to the base station when the leftover power of the UE is not larger than the threshold, when the first estimated time period is not shorter than the second estimated time period, and when the next available pre-scheduling UL resource is enough to transmit the BSR.

18. The method of claim 14, further comprising, after the step (b), transmitting, by the UE, the SR to the base station when the leftover power of the UE is not larger than the threshold, when the first estimated time period is not shorter than the second estimated time period but the next available pre-scheduling UL resource is not enough to transmit the BSR, and the step (c) is performed by transmitting, by the UE, the BSR using the dedicated UL resource.

19. A wireless communication resource scheduling method, comprising:
(a) receiving, by an base station, a scheduling request (SR) from a user equipment (UE);
(b) receiving, by the base station, at least one buffer status report (BSR) from the UE after receipt of the SR;
(c) determining, by the base station, whether the at least one buffer status report (BSR) is received within a predetermined period after receipt of the SR; and
(d) selectively transmitting, by the base station, either one or two uplink (UL) scheduling grants to the UE based on a determination of the step (c).

20. The method of claim 19, wherein the step (d) is performed by transmitting, by the base station, the one UL scheduling grant to the UE to respond to the at least one BSR without transmitting another UL scheduling grant to the UE to respond to the SR when the at least one buffer status report (BSR) is received within the predetermined period after receipt of the SR.

21. The method of claim 19, wherein the step (d) is performed by transmitting, by the base station, the one UL scheduling grant to the UE to respond to the SR and another one UL scheduling grant to the UE to respond to the at least one BSR when the at least one buffer status report (BSR) is received not within the predetermined period after receipt of the SR.
